(19) United States
(12) Patent Application Publication
(10) Pub. No.: US 2002/0160069 A1
(43) Pub. Date: Oct. 31, 2002

(54) Crystallization machine for a mouth on a plastic bottle blank

(76) Inventor: Kuang-Tse Chin, Taichung (TW)

Correspondence Address: CONNOLLY BOVE LODGE & HUTZ, LLP, 1220 N MARKET STREET, P O BOX 2207, WILMINGTON, DE, 19899

(21) Appl. No.: 09/943,732

(22) Filed: Aug. 31, 2001

(30) Foreign Application Priority Data
Apr. 25, 2001 (TW) 090206775

(51) Int. Cl. B29C 49/68

(52) U.S. Cl. 425/143; 425/170; 425/526; 425/534; 425/445

(57) ABSTRACT

A crystallization machine for a mouth on a bottle blank provides different heat sources to heat up the mouth of the bottle blank. The crystallization machine also provides an automatically controlled system to precisely control the dimension of the crystallized mouth of the bottle blank. Hence, the crystallization machine can be performed to increase the productivity, save energy, reduce the production cost, and enhance the competitiveness for the maker.

### BACKGROUND OF THE INVENTION

1. Field of the Invention

The present invention relates to a crystallization machine for a mouth on a plastic bottle blank, and, particularly, to a crystallization machine, which can enhance the production efficiency and the quality while the plastic bottle blank is treated for crystallizing the mouth thereof.

2. Description of Related Art

Now, applying a single infrared radiation to perform the heating job in the crystallization machine for a mouth on a plastic bottle has been adopted conventionally in the whole world. The heat energy from the heat source of infrared radiation is sent to the outer surface of the mouth on a plastic bottle blank directly, and the mouth is crystallized during the process of heating. The crystallization conducted by the conventional crystallization machine gets involved in the following shortcomings:

(1) The mouth is easily deformed to change the configuration thereof resulting from absorbing the radiation unevenly due to the threaded area of the mouth being made with irregular screw threads and a non-homogeneous thickness.

(2) In order to avoid the phenomenon of being deformed during stripping, the mouth of the plastic bottle blank usually is cooled excessively, but the over cooled mouth makes the stripping job more difficult to perform.

(3) The temperature at the inner side of the mouth is not possible to be controlled properly so that it makes the above two problems worse.

(4) In order to keep a good shape and a precise dimension for the mouth and perform a smooth stripping job, it is not possible for the conventional crystallization machine to increase the speed of the production in a very limited processing window.

(5) The cycling conveyer mechanism for delivering the plastic bottle in the conventional crystallization machine usually is designed to move around horizontally such that it provides a very large size but a small capability so that the beneficial result of economics thereof is unfavorable.

Accordingly, the subject with regard to the deficiencies of the conventional crystallization machine is worth us to overcome although it may provide the basic function thereof and has its economic value.

### SUMMARY OF THE INVENTION

The present invention adopts two sets of radiation heat sources in conjunction with an operation of an integrated machine system to increase the production in addition to the accurate size thereof being needed to maintain so as to solve the problems confronted by the conventional crystallization machine such as a difficultly operated production system and a low efficiency of production.

An object of the present invention is to provide a crystallization machine for a mouth on a plastic bottle blank, in which a shift device and a loader device are arranged to move synchronously such that the plastic bottle blank can fit with the loader device reliably and move correctly during being fed into the machine.

Another object of the present invention is to provide a crystallization machine for a mouth on a plastic bottle blank, in which a stripping tool will not contact an opening end of the mouth on the plastic bottle blank and the threaded area thereof to keep an accurate dimension of the mouth without being deformed.

A further object of the present invention is to provide a crystallization machine for a mouth on a plastic bottle blank, in which a closed feed back system with a pyrometer are arranged therein to control the temperature at the inner side of the plastic bottle blank in a range of 70° C.˜200° C. for maintaining an unchanged dimension of the bottle blank during stripping.

A further object of the present invention is to provide a crystallization machine for a mouth on a plastic bottle blank, in which a dual conveying system with a vertically moving cycle is adopted such that the crystallization machine can occupy a less space to treat multiple times of plastic bottle blanks with a least production cost.

A further object of the present invention is to provide a crystallization machine for a mouth on a plastic bottle blank, which can increase the production efficiency in addition to an accurate crystallized size being obtained.

A further object of the present invention is to provide a crystallization machine for a mouth on a plastic bottle blank, which can increase the effectiveness of a heater zone therein to decrease a waste of energy in the heater therein.

### BRIEF DESCRIPTION OF THE DRAWINGS

The present invention can be more fully understood by reference to the following description and accompanying drawings, in which:

FIG. 1 is a diagrammatic view of a crystallization machine for a mouth on a plastic bottle blank according to the present invention illustrating a front half part thereof;

FIG. 2 is a diagrammatic view of a crystallization machine for a mouth on a plastic bottle blank according to the present invention illustrating a rear half part thereof;

FIG. 3A is a diagrammatic view of input zone in the crystallization machine for a mouth on a plastic bottle blank;

FIG. 3B is a perspective view of a shift device in the input zone of the crystallization machine for a mouth on a plastic bottle blank according to the present invention;

FIG. 3C is a diagrammatic view of a loader on a conveyer contacting with a transmission gear disk in the shift device according to the present invention;

FIG. 3D is a perspective view illustrating a plastic bottle blank fitting with the loader in the shift device;

FIG. 4 is a plan view of locating wheels at the upper portion of the crystallization machine of the present invention;

FIG. 5 is a diagrammatic view of a heater zone at the upper portion of the crystallization machine of the present invention;

FIG. 6 is an enlarged plan view of the heater zone shown in FIG. 5;

FIG. 7A is a diagrammatic view of a releasing zone in the crystallization machine for a mouth on a plastic bottle blank according the present invention;

FIG. 7B is a side view of FIG. 7A;

FIG. 8 is a plan view of a stripping plate attached to the loader device illustrating the stripping plate in a state of performing to detaching the plastic bottle blank; and

FIG. 9 is a diagrammatic view illustrating two temperature sensors attached to the crystallization machine for a mouth on a plastic bottle blank of the present invention.

### DETAILED DESCRIPTION OF THE PREFERRED EMBODIMENT

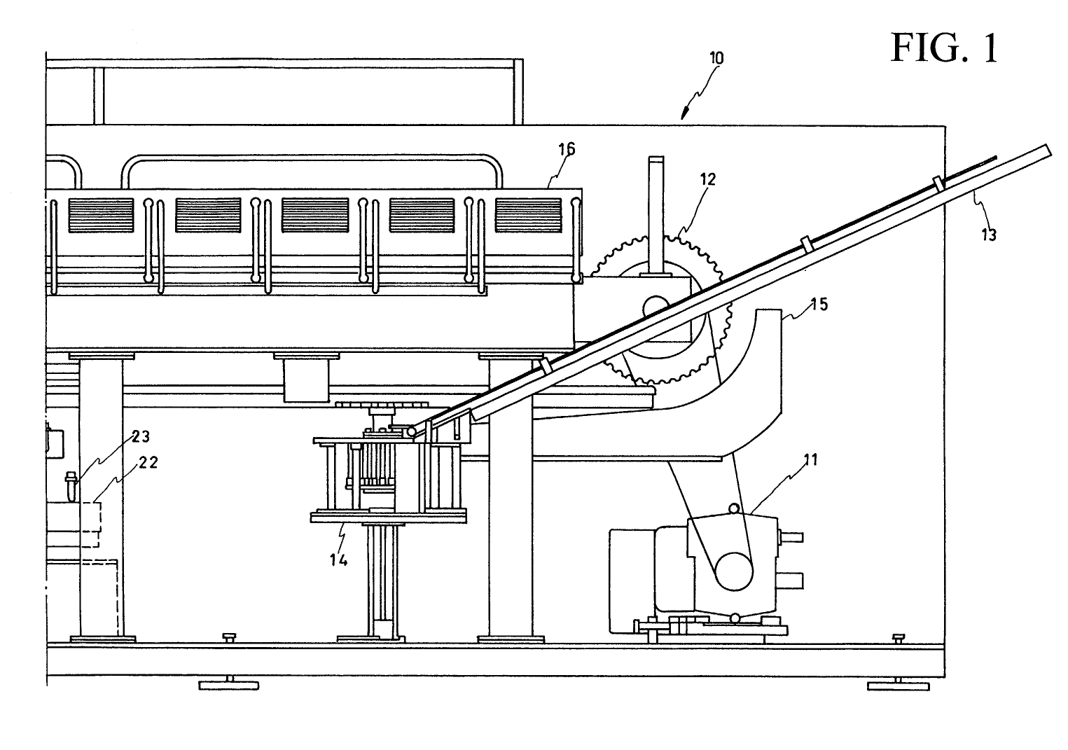

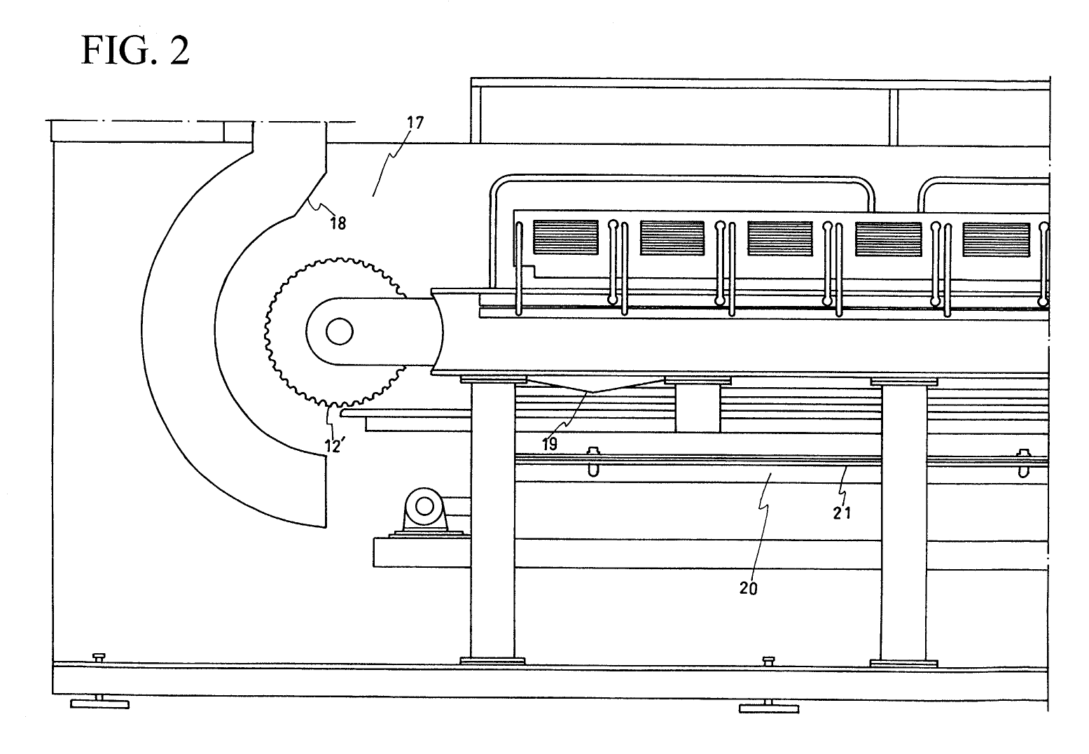

Referring to FIGS. 1, and 2, a crystallization machine 10 for a mouth on a plastic bottle blank according to the present invention provides a motor 11 to drive a front conveyer gear disk 12 and the conveyor gear disk 12 actuates a conveyor (not shown) to move above and below a heater zone 16. The crystallization machine 10 at the front end thereof is fixedly disposed a respective feed element 13 near both lateral sides thereof. The respective feed element 13 extends inward in a tilt way to connect with a shift device 14. The shift device 14 is fixedly located under the conveyer and a positioning slide rail 15 is mounted between the front gear disk 12 and the shift device 14. The shift device 14 keeps bottle blanks 23 in a state of being upright during the process of crystallizing. The crystallization machine 10 at the rear portion thereof is a cooling zone 17 and a blowing device (not shown) with a blowing pipe 18 is provided at the back of the cooling zone 17. The outlet of the blowing pipe 18 is under a rear conveyor gear disk 12′ disposed at the cooling zone and opposite to the front conveyor gear disk 12. A releasing track 19 is disposed in front of the rear conveyer gear disk 12′ next to the blowing pipe 18. An output track 21 is disposed under the releasing track 19 and the outlet of the blowing pipe 18 faces the output track 21, that is, the wind from the blowing device blows toward the output track 21 so as to constitute a back cooling zone 20. The bottle blanks 23 are delivered to a collect zone 22 after being crystallized and cooled. This is a brief introduction of the crystallization machine and an operation for crystallizing the bottle blanks 23.

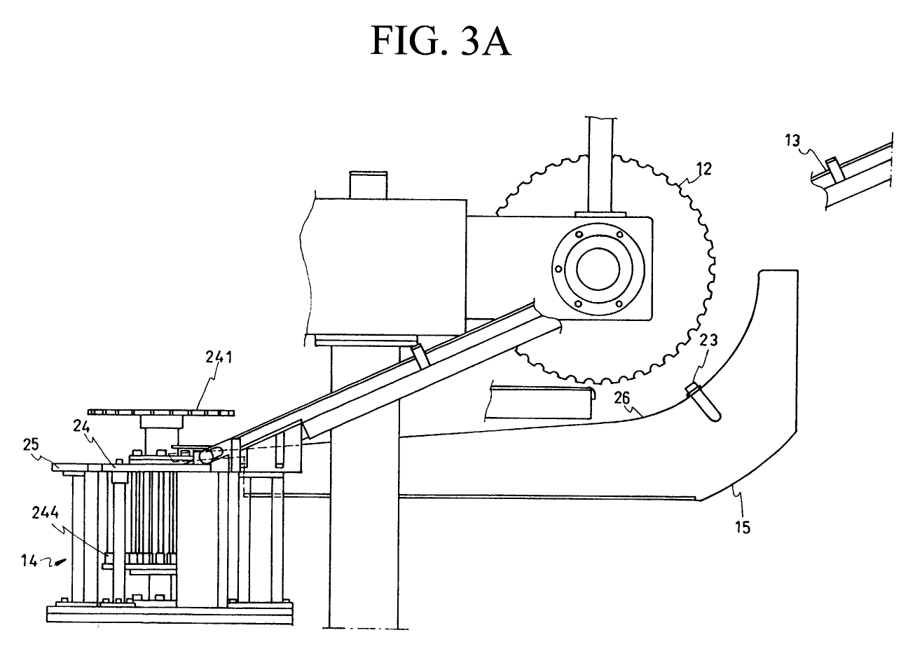

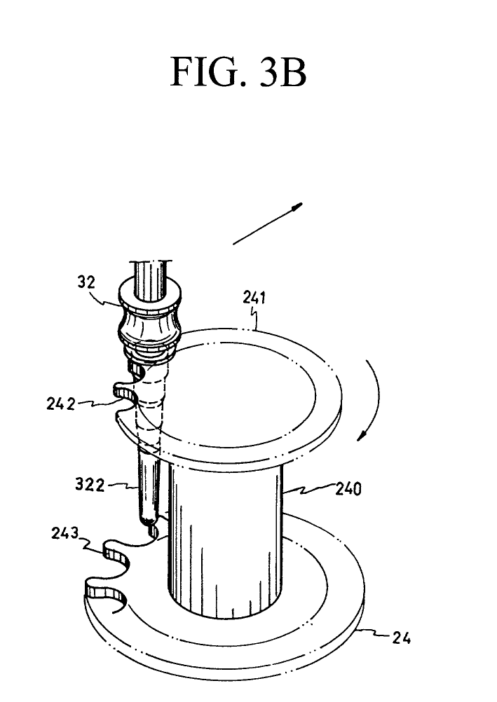

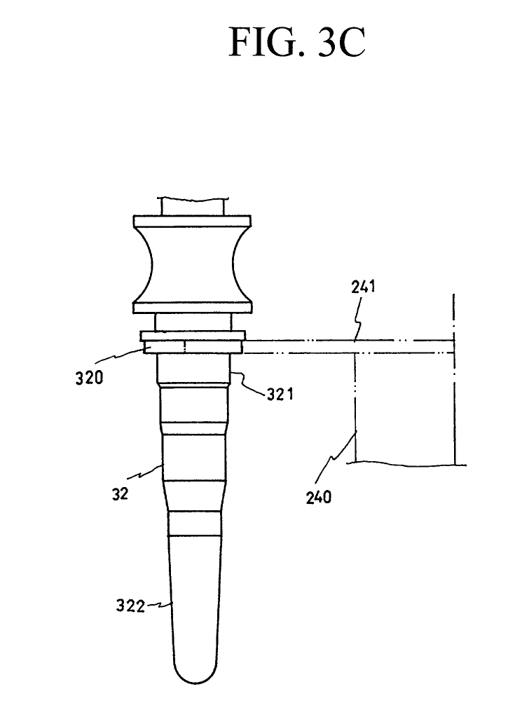

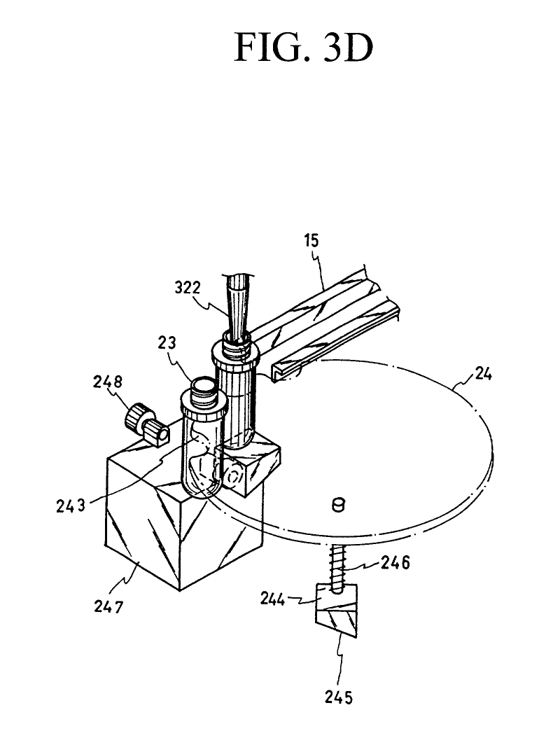

Referring to FIG. 3A, a process of feeding the bottle blanks 23 is illustrated. As soon as the crystallization machine 10 starts to run, the respective bottle blank 23 is fed into a rotary disk 24 on the shift device 14 from the feed element 13 and the rotary disk 24 at the circumference thereof provides a shape like gear teeth such that the respective bottle blank 23 can be inserted into a gap between two neighboring teeth thereof. A protect barrier 25 is mounted to surround the rotary disk 24 for preventing the respective bottle blank 23 from falling down while the rotary disk 24 is in a state of turning. The respective plastic bottle blank 23 rotates synchronously with the rotary disk 24 and transfers to the positioning slide rail 15 as soon as the respective bottle blank 23 is turned to a connection end of the positioning slide rail 15. The rotation of the rotary disk 24 causes the plastic bottle blank 23 to move along a guide surface 26 on the positioning slide rail 15 in an ascendant way gradually.

Referring to FIG. 3B with accompanying FIG. 3A again, a detail of the shift device 14 is illustrated. A plurality of loaders 32 are provided on the conveyer to drive the shift device 14. The rotary disk 24 of the shift device 14 at the central portion thereof extends upward a central shaft 240. Each of the loaders 32 is preferably made of engineering plastics to avoid being worn out so as to maintain the accuracy thereof. The central shaft 240 at the upper end thereof is fixedly attached a transmission gear 241 to mesh with the middle part of the loader 32 by way of a teeth part 242 thereof. As soon as the conveyer moves, the loader 32 can actuate the transmission gear 241 to rotate and cause the rotary disk 24 to rotate via the central shaft 240. As it has been mentioned previously, the periphery of the rotary disk 24 has a gear like shape so that there are receiving recesses 243 provided for receiving the bottle blanks respectively. Hence, the bottle blanks 23 received in the respective recess 243 are inserted by the support post 322 of one of the loaders 32 respectively such that the bottle blanks 23 are moved by the loaders 32 respectively as soon as the conveyer moves along with the loaders 32. In the mean time, the respective loader 32 carrying the respective bottle blank 23 can be sleeved into the respective bottle blank 23 while the bottle blanks 23 inter the positioning rail 15 and ascend along the guide surface 26. This is a design that each bottle blank 23 to be treated in the crystallizing machine 10 is corresponding to one of the loaders 32 on the conveyor and the conveyer and the shift mechanism 14 can be performed by a set of driving system instead of two sets of different driving systems. Therefore, the bottle blanks 23 can move with the loaders 32 synchronously to overcome the puzzle resulting from the need of adjusting the movement of the respective bottle blank 23 in accordance with the respective loader 32.

Referring to FIG. 3C, the loader 32 provides a fitting section 321 for fitting with the mouth of a bottle blank and a contact part 32 next to and above the fitting section 321 for contacting with the transmission gear disk 241 instead of the fitting section 321 being contacted by the transmission gear disk 241. In this way, it is possible for the fitting section 321 to avoid the outer diameter thereof being worn out and to fit with the inner diameter of the mouth on the bottle blank well afterward so that even if the transmission gear disk 241 is made of metal instead of the engineering plastics, it is not necessary to worry about the problem of the fitting section being worn out.

Referring to FIG. 3D, a fixing base 247 is disposed between two rotary disks 24, which are corresponding to the two parallel conveyers respectively and it is noted that one rotary disk is shown in FIG. 3 only, and the fixing base 247 at the upper end thereof is fixedly attached with two rollers 248 opposite to each other and corresponding to the two rotary disks 24 respectively. Each rotary disk 24 is slidably attached with a plurality wedge blocks 244 and each wedge block 244 at the top thereof is urged by a spring 246 and the bottom thereof is a tilt plane 245. When the respective rotary disk 24 at both lateral sides of the fixing base 247 rotate, each wedge block 244 thereon rotates synchronously and the tilt plane 245 touches the respective roller 248 so that the wedge block 244 can move upward at the same time to push the bottle blank 23 moving upward. In this way, the threaded part of the bottle blank 23 may higher than the guide rail 15 to allow the mouth of the bottle blank 23 piercing the support post 322 so that the bottle blank 23 can be moved outward to enter the positioning slide rail 15 with the support post 233. Thus, the bottle blank 23 can move along the positioning slide rail 15 such that the bottle blank 23 can move upward gradually to enter the heater zone for being heated up and the mouth thereof can fit with the loader 32 completely at the same time.

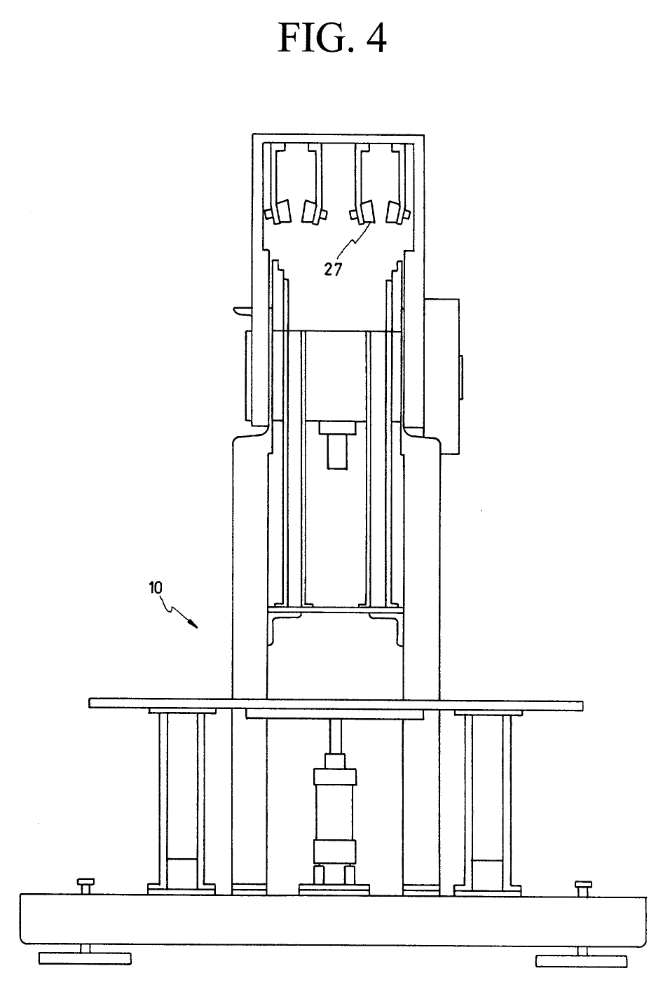

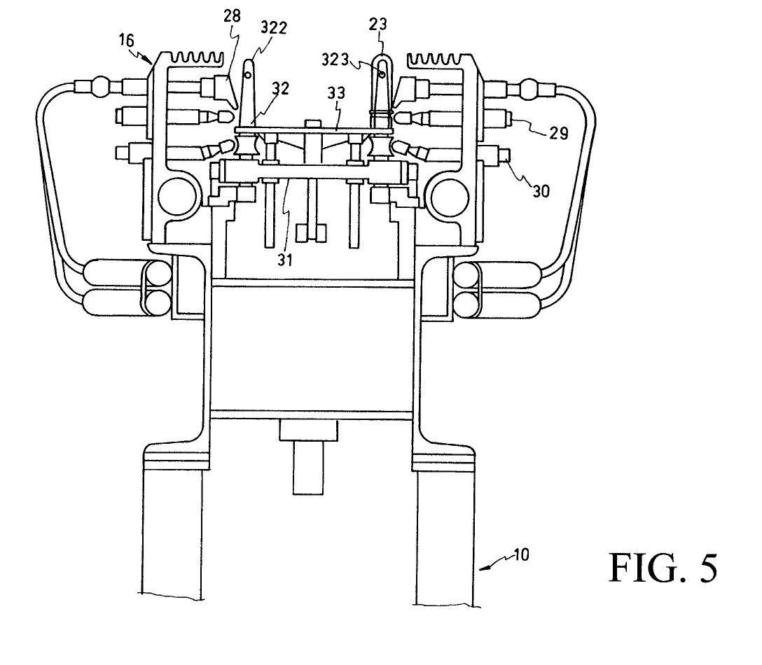

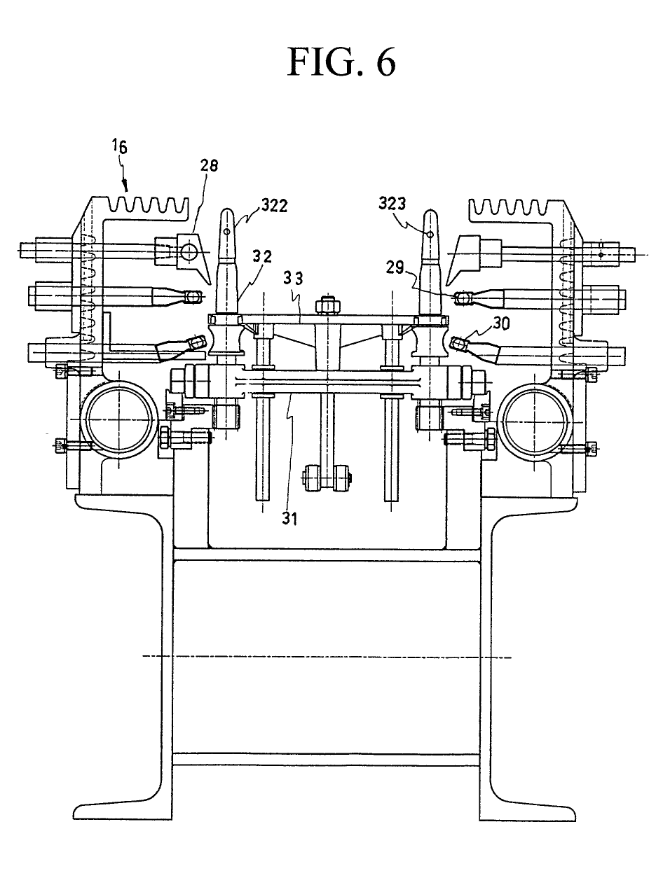

Referring to FIGS. 4, 5 and 6, a plurality of locating wheels 27 and a heater zone 16 are disposed at the upper portion of the crystallization machine 10 and the bottle blank 23 is delivered to the heater zone 16 by way of the actuation of the front conveyer gear disk 12. The bottle blank 23 passes over a passage between the locating wheels 27 and two opposite sides of the bottle blank 23 are pressed down by the locating wheels 27 to have the mouth of the bottle blank fitting with the loader 32 completely. The heater zone 16 at both lateral sides thereof provides an upper heat source 29 and a lower heat source 30 respectively and the upper heat source 29 at the upper end thereof has a cover shade 28 to prevent the heat source from expanding upward. The heat from the upper heat source 29 directs to the threaded part of the mouth on a bottle and the heat from the lower heat source 30 directs to the root of the loader 32 such that the heat can be transferred to inner surface of the threaded part in the bottle blank 23 and a proper temperature can be maintained in the respective plastic bottle blank 23 to facilitate the respective plastic bottle blank 23 being released easily. The support post 32 of the loader 32 presses against the inner side of the lower part of the bottle blank 23 to prevent the threaded part thereof from softening due to the heat during the process of crystallizing and from being deformed due to the weight of the respective plastic bottle blank 23 itself. The support post 322 has an air aperture 323 to discharge the air staying in the respective bottle blank 23 during heating and the discharged air can be removed to outside through the central part of the bottle blank. The respective loader 32 is fixedly attached to the conveying loaders 31, which connect with each other in series to form the conveyer. A stripping plate 33 is disposed on the respective conveying loader 31 and rests at a flange ring under the threaded part to push the bottle blank 23 for stripping the respective plastic bottle blank from the loader 32.

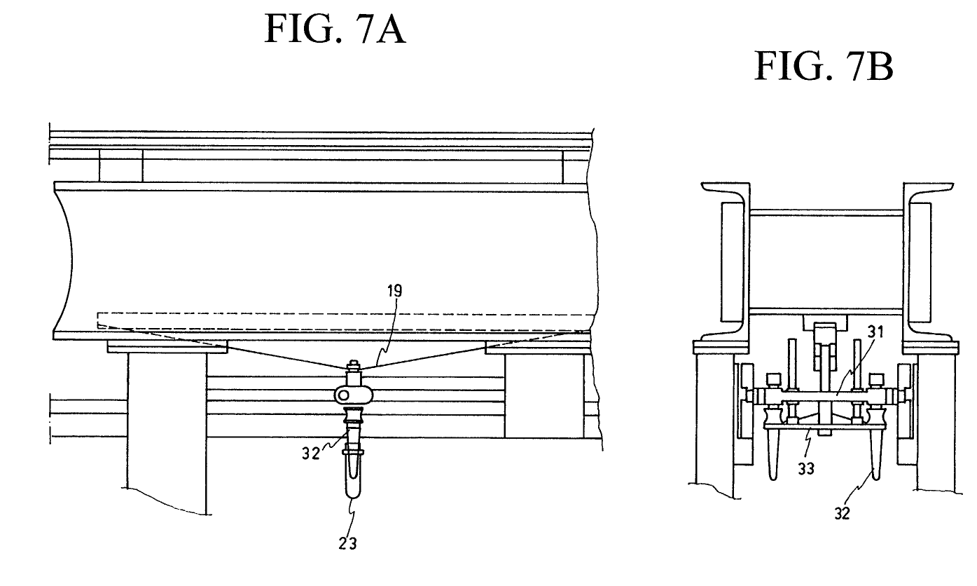

Referring to FIGS. 2, 6, 7A and 7B, the respective plastic bottle blank 23 is delivered to the cooling zone 17 as soon as the respective plastic bottle blank 23 is moved out from the heater zone 16, the outer surface of the threaded part thereof is cooled down quicker and the inner side of the threaded part thereof is cooled down slower due to the loader 32 being a high temperature. The respective conveying loader 31 becomes inversed because of being driven by the rear conveying gear disk 12′ at the rear side of the crystallization machine 10 and the respective stripping plate 33 is located above the respective plastic bottle blank 23. As soon as the respective conveying loader 31 moves to the release track 19, the respective stripping plate 33 slides downward to push the respective plastic bottle blank 23 such that the respective plastic bottle blank 23 can be apart from the loader 32 and fall down to the output track 21. The respective plastic bottle blank 23 on the output track 21 can be delivered to the collection zone 22 and the wind from the blowing pipe 18 may flow toward the respective plastic bottle blank 23 and further cools the respective plastic bottle blank 23.

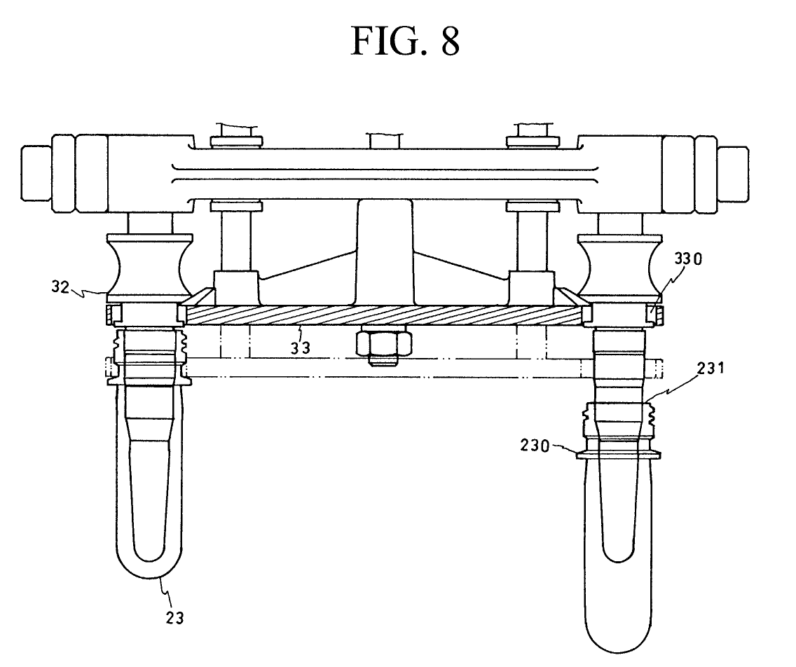

Referring to FIG. 8, the stripping plate 33 provides a through hole 330 and an inner diameter of the through hole 330 is greater than the size of the threaded area on the mouth of the respective plastic bottle blank 23 so that the respective stripping plate 33 presses against the support ring 230 below to push the respective plastic bottle blank 23 away the respective loader 32 to keep the end of the mouth 231 and the threaded area of the respective plastic bottle blank off being deformed and to maintain a precise dimension thereof. But, the conventional stripping job is performed by way of the respective plastic bottle blank 23 being separated from the respective loader 32 from the mouth 231, and the mouth 231 may be deformed easily and becomes a defection.

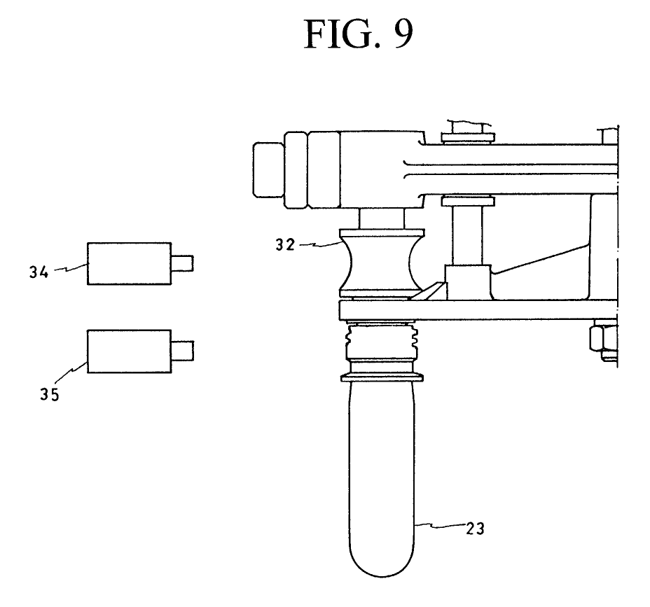

Referring to FIG. 9, the temperature control sensor utilized in the present invention is composed of a closed loop feedback control system with a non-contact type of pyrometer. But, it is noted that it is only for taking an example and other types of temperature control sensor may be used as long as it is suitable for the present invention.

The sensors 34, 35 are disposed at the rear side of the heater zone 16, and the sensor 34 is used for sensing the temperature of the loader 32 and the sensor 35 is used for sensing the temperature at the threaded part of the bottle blank 23. The temperatures sensed by the sensors 34, 35 are fed back to the closed loop control system and control system then controls and adjusts the temperatures at the threaded area of the bottle blank and the loader 32 respectively. In this way, the threaded area of the mouth on the bottle blank can maintain a correct size and is feasible for being stripped off the loader.

It is appreciated that the features of the present invention can be summarized hereinafter:

(1) The bottle blanks are delivered by way of double conveyers so that it is possible to speed up the treatment of crystallization for the bottle blanks and increase the productivity.

(2) The stripping device does not affect the original size of the respective bottle blank, especially at the most important part thereof, while the bottle blank is complete for the treatment of crystallization and is released from the crystallization machine. Hence, the rate of defection resulting from the deformation can be lowered substantially.

(3) The loader used in the present invention can be controlled by a closed loop sensing system so that the temperature of the loader can be controlled steadily. Hence, the bottle blank can be stripped from the loader easily to maintain the crystallized product in a state of stable and high quality.

(4) Comparing to the conventional crystallization machine, a much higher efficiency for the production of the present invention can be obtained so that the economic effect resulting from the production of the present invention can be reached desirably.

Apparently, it can be made a general comment that the present invention not only enhances the crystallizing effect for the plastic bottle blank but also overcomes the defects with regard to the mouth of the bottle blank being deformed easily during being stripped and the difficulty resulting from stripping the plastic bottle blank. In the mean time, the capacity of production provided by the crystallization machine can be expanded easily as soon as the heater zone is extended in length thereof and the running speed of the crystallization machine is increased. Therefore, the quality of the crystallized mouth of the plastic bottle blank can promoted substantially through the treatment of the present invention so that the present invention is a great breakthrough in the field of crystallization machine for treating the mouth of a plastic bottle blank.

While the invention has been described with reference to the preferred embodiment, it is to be understood that modifications or variations may be easily made without departing from the spirit of the invention, which is defined by the appended claims.

What is claimed is:

1. A crystallization machine for a mouth on a bottle blank, comprising:
a conveying mechanism, providing two parallel cycling conveyers, being located at a middle part thereof, carrying a plurality of loaders, and each of the loaders providing a post with a fitting part for fitting with the mouth of the bottle blank;
an input zone, being located at a lateral side or two opposite sides of the crystallization machine at a lower part thereof, further comprising a feed element, a shift device connecting with the feed element, and a positioning slide rail being joined to the shift device, and the shift device being in conjunction with the conveyer or the two conveyers in series;
a heater zone, being disposed at an upper part thereof;
a cooling zone, being disposed next to a rear end of the heater zone;
a releasing zone, being disposed at the lower part thereof next to the input zone;
a rear cooling zone, being disposed under the releasing zone next to a middle part of the releasing zone; and
an output zone, connecting with the rear cooling zone;
whereby, a plurality of plastic bottle blanks at the input zone are delivered by the conveyer or the conveyer to the heater zone at the upper part of the crystallization machine, and are turned to the releasing zone at the lower part of the crystallization machine via a rear end of the conveyer; and then the crystallized plastic bottle blanks are removed outward the output zone.

2. The crystallization machine for a mouth on a bottle blank according to claim 1, wherein the shift device further comprises:
a rotary disk with a gear like periphery for locating the bottle blanks,
a central shaft with a transmission gear disk extending upward from the rotary disk,
and a protect carrier surrounding the rotary disk to prevent the bottle blanks from falling out;
wherein, the rotary disk provides two connecting ends to connect with the feed element and the positioning slide rail respectively, and a gap between any two teeth on the rotary disk aligns with a gap between any two teeth on the transmission gear so as to be inserted by a loader on the conveyer or on one of the conveyers for driving the input rotary disk.

3. The crystallization machine for a mouth on a bottle blank according to claim 1, wherein a meshing part is disposed above the fitting part on the loader for meshing with conveying gear disk.

4. The crystallization machine for a mouth on a bottle blank according to claim 2, wherein a plurality of ascend wedges are vertically movably attached to and disposed under the rotary disk and each ascend wedge has a tilt bottom; and a roller is disposed near the rotary disk to be slidably contacted by the tilt bottom such that the ascend wedges can move upward during rotating with rotary disk.

5. The crystallization machine for a mouth on a bottle blank according to claim 1, wherein the positioning slide rail has a slant guide surface extending from the input rotary disk to the conveyer or the conveyers so that the bottle blank can be moved along the slant guide surface and inserted into the loader so as to move with the loader.

6. The crystallization machine for a mouth on a bottle blank according to claim 1, wherein the post on the respective loader supports the bottle blank thereon to prevent a threaded area of the mouth on the bottle blank from being softened by the heat of the heater zone and being deformed by the weight of the bottle blank it self.

7. The crystallization machine for a mouth on a bottle blank according to claim 1, wherein the post on the loader has an air aperture to discharge the air in the bottle blank out of the loader.

8. The crystallization machine for a mouth on a bottle blank according to claim 1, wherein the conveying mechanism a plurality of stripping plates and each of the stripping plates has a through hole respectively corresponding to a support ring on the respective plastic bottle blank for detaching the bottle blanks from the loaders.

9. The crystallization machine for a mouth on a bottle blank according to claim 1, wherein the heater zone provides a set of upper heat sources for heating a threaded area of the mouth on the respective bottle blank and a set of lower heating sources for heating the loaders.

10. A crystallization machine for a mouth on a bottle blank, comprising:
a conveying mechanism, providing one cycling conveyer or two parallel cycling conveyers, being located at a middle part thereof, carrying a plurality of loaders, and each of the loaders providing a post with a fitting part for fitting with the mouth of the bottle blank;
an input zone, being located at a lateral side or two opposite sides of the crystallization machine at a lower part thereof, further comprising a feed element, a shift device connecting with the feed element, and a positioning slide rail being joined to the shift device, and the shift device being in conjunction with the conveyer or the two conveyers in series;
a heater zone, being disposed at an upper part thereof;
a cooling zone, being disposed next to a rear end of the heater zone;
a releasing zone, being disposed at the lower part thereof next to the input zone;
a rear cooling zone, being disposed under the releasing zone next to a middle part of the releasing zone; and
an output zone, connecting with the rear cooling zone,
two non-touch type infrared sensors, being disposed at a rear side of the heater zone, one of the sensors detecting a temperature at a threaded part of the mouth on the bottle blank, and the other sensor detecting a temperature of the loaders with feed back control system to control the temperature at the loaders for the bottle blanks being stripped easily.
whereby, a plurality of plastic bottle blanks at the input zone are delivered by the conveyer or the conveyer to the heater zone at the upper part of the crystallization machine, and are turned to the releasing zone at the lower part of the crystallization machine via a rear end of the conveyer; and then the crystallized plastic bottle blanks are removed outward the output zone.

11. The crystallization machine for a mouth on a bottle blank according to claim 10, wherein the shift device further comprises:
a rotary disk with a gear like periphery for locating the bottle blanks,
a central shaft with a transmission gear disk extending upward from the rotary disk,
and a protect carrier surrounding the rotary disk to prevent the respective plastic bottle blanks from falling out;
wherein, the rotary disk provides two connecting ends to connect with the feed element and the positioning slide rail respectively, and a gap between any two teeth on the rotary disk aligns with a gap between any two teeth on the transmission gear so as to be inserted by a loader on the conveyer or on one of the conveyers for driving the input rotary disk.

12. The crystallization machine for a mouth on a bottle blank according to claim 10, wherein a meshing part is disposed above the fitting part on the loader for meshing with transmission gear disk.

13. The crystallization machine for a mouth on a bottle blank according to claim 11, wherein a plurality of ascend wedges are vertically movably attached to and disposed under the rotary disk and each ascend wedge has a tilt bottom; and a roller is disposed near the rotary disk to be slidably contacted by the tilt bottom such that the ascend wedges can move upward during rotating with rotary disk.

14. The crystallization machine for a mouth on a bottle blank according to claim 1, wherein the positioning slide rail has a slant guide surface extending from the input rotary disk to the conveyer or the conveyers so that the respective plastic bottle blank can be moved along the slant guide surface and inserted into the loader so as to move with the loader.

15. The crystallization machine for a mouth on a bottle blank according to claim 1, wherein the post on the respective loader supports the respective bottle blank thereon to prevent a threaded area of the mouth on the respective plastic bottle blank from being softened by the heat of the heater zone and being deformed by the weight of the respective bottle blank it self.

16. The crystallization machine for a mouth on a bottle blank according to claim 1, wherein the post on the loader has an air aperture to discharge the air in the bottle blank out of the loader.

17. The crystallization machine for a mouth on a bottle blank according to claim 1, wherein the conveying mechanism provides a plurality of stripping plates and each of the stripping plates has a through hole respectively corresponding to a support ring on the respective plastic bottle blank for detaching the respective plastic bottle blank from the loaders.

18. The crystallization machine for a mouth on a bottle blank according to claim 1, wherein the heater zone provides a set of upper heat sources for heating a threaded part of the mouth on the respective bottle blank and a set of lower heating sources for heating the loaders.
